(19) United States
(12) Patent Application Publication
(10) Pub. No.: US 2004/0184611 A1
(43) Pub. Date: Sep. 23, 2004

(54) Copy protection of digital data

(76) Inventor: Richard A. A. Heylen, Leeds (GB)

Correspondence Address: PATENT DEPARTMENT, MACROVISION CORPORATION, 2830 DE LA CRUZ BLVD., SANTA CLARA, CA, 95050, US

(21) Appl. No.: 10/754,368

(22) Filed: Jan. 9, 2004

Related U.S. Application Data
(60) Provisional application No. 60/439,248, filed on Jan. 10, 2003.

(30) Foreign Application Priority Data
Jan. 10, 2003 (GB) 0300596.4

(51) Int. Cl. H04N 7/167

(52) U.S. Cl. 380/201

(57) ABSTRACT

Digital data which is to be encoded, for example, for application to a CD, is subjected to error correcting encoding and is arranged in codewords, with each codeword containing data bytes and parity values. To copy protect such encoded digital data, the values of the data in a number of the data bytes in a selected codeword are altered. For audio data, for example, the values of the data bytes are altered to be representative of an unusually large magnitude, or click. It is also arranged that the alterations to the values of the data bytes and the number of data bytes altered render the altered codeword uncorrectable. This means that on decoding, for example, in a CD player, the decoder flags the codewords as uncorrectable whereby the data is subjected to interpolation or other error concealment. The clicks are therefore not imposed on the audio as played. However, copies which are made from the copy protected encoded digital data will generally be degraded.

### CROSS REFERENCE TO RELATED APPLICATIONS

This application claims priority to U.S. provisional application S No. 60/439,248 filed Jan. 20, 2003.

### FIELD OF THE INVENTION

The present invention relates to a method of copy protecting digital data and to copy protected media on which the digital data is stored.

### BACKGROUND OF THE INVENTION

Digital audio compact discs (CD-DA) which carry music or other audio can be played or read by more sophisticated apparatus, such as CD-ROM drives. This means, for example, that the data on a CD-DA acquired by a user may be read into a PC by way of its ROM drive and thus copied onto another disc or other recording medium. The increasing availability of recorders able to write to CDs is therefore an enormous threat to the music industry.

In an earlier proposed method, a digital audio compact disc is copy protected by rendering control data encoded onto the disc incorrect and/or inaccurate. The incorrect data encoded onto the CD is either inaccessible to, or not generally used by, a CD-DA player. Therefore, a legitimate audio CD bought by a user can be played normally on a compact disc music player. However, the incorrect data renders the CD unplayable by a CD-ROM drive.

However, as the audio compact disc is rendered unplayable on a CD-ROM drive, the user is also prevented from using the CD-ROM drive legitimately simply to play the music or other audio on the disc.

What is needed is a method of copy protection for a digital audio compact disc which, whilst preventing the production of usable copy discs, does not prevent or degrade the playing of protected audio discs on all players having the functionality to play audio discs.

WO 01/15028 discloses a method of copy protecting a CD-DA in which errors are introduced into the audio data itself, with a consequent change made to parity values associated therewith, such that the errors are identified as ‘uncorrectable’ by the error correction arrangements normally provided in audio players or data readers. As a result, an audio player will conceal the errors, for example by substituting interpolated values for audio data identified as erroneous, whereas a data reader will either fail to read the erroneous data or will simply read the erroneous values. The uncorrectable errors on the CD-DA will, therefore, make it difficult to produce a usable copy of the protected CD-DA, for example, by adding unacceptable noise when a copy of the protected CD-DA is played.

A similar method of copy protecting encoded digital data is described in our copending British patent application No. 0116278.3. However, in this proposal, each codeword including data errors is changed by adding to it a value representative of an uncorrectable error identifying syndrome. This effectively changes the parity values. The use of a syndrome representative value to change each codeword should provide reliability on decoding irrespective of the values of the digital data.

Whilst the copy protection schemes described in WO 01/15028 and GB 0116278.3 work well, there is always a need for alternative copy protection schemes and the present invention seeks to provide such an alternative.

### SUMMARY OF THE INVENTION

According to a first aspect of the present invention there is provided a method of copy protecting encoded digital data wherein the encoded digital data has been subjected to error correcting encoding and is arranged in codewords, each codeword containing data bytes and parity values, the method comprising the steps of altering the value of the data in a plurality of data bytes in a selected codeword, to form an altered codeword, the nature of the altered values and the number of data bytes altered being chosen to render the altered codeword uncorrectable.

Methods of the invention are specifically adapted for use with encoded digital data which can be successfully interpolated or subjected to error concealment after decoding for playback.

Embodiments of a method of the invention alter the data values and not the parity values. As the data values are altered in the codeword, the alteration occurs after encoding such that the data will not be consistent with the parity values, and hence will be readily detectible as erroneous. Copies which are produced from the copy protected source will generally be degraded. In general, with embodiments of the invention, where the level of degradation of the encoded digital data is comparable to that produced by schemes as described in WO 01/15028 or GB 0116278.3, the number of uncorrectable errors introduced by the invention will be reduced as compared to the earlier schemes.

In a preferred embodiment, the method further comprises altering the values of the data in at least four data bytes in a selected codeword. For example, the values of the data in at least five data bytes in a selected codeword are altered.

In this respect, it has been established that the best decoders incorporated in data readers for CD's might be able to cope with four errors in one row, but will generally not be able to do anything other than mark a row as uncorrectable where five data bytes incorporate errors.

In an embodiment, only selected nibbles of each data byte are altered.

Additionally and/or alternatively, the data bytes in a selected codeword are grouped into multibyte numbers, and only the most significant bytes of a number are altered.

In this respect, it is wished to provide a balance between the number of errors which are provided and which degrade a copy of the source material, and the need not to overwhelm the decoder used to legitimately play the source.

In one embodiment, one or more higher order bits of each data byte of the plurality of data bytes are altered to be representative of an unusually large magnitude, and the remaining lower order bits of each data byte of the plurality of data bytes are altered such that, on decoding, the altered codeword will generate an uncorrectable error identifying syndrome.

For example, the most significant nibble of each data byte of the plurality of data bytes may be altered to be representative of an unusually large magnitude, and the least significant nibble of each selected data byte may be altered such that, on decoding, the altered codeword will generate an uncorrectable error identifying syndrome.

In a preferred embodiment, the values of a data byte are altered to produce a data byte representative of data of an unusually large magnitude. For example, where the encoded data is audio, the altered value data byte may be representative of a spike.

The present invention has utility for protecting any digital data where errors in the digital data are to be identified or corrected whilst accessing the data, and where any errors identified as uncorrectable would generally be interpolated, or otherwise concealed, during playback. In these circumstances, it is to be expected that the incorporation of unusually large magnitude values, for example, of spikes, in the data would generally degrade any copies produced irrespective of the nature of the original data. Where a method of the invention is used to copy protect digital audio compact discs, it is known that the provision of spikes on the audio data will produce audible clicks.

As set out above, it is important that a decoder reliably identifies an altered codeword, which has altered data values, as uncorrectable. In this respect, where the digital data to be played, for example, is audio or visual images, or video, the player would generally be provided with error concealment means such as an interpolator. The identification, therefore, of altered codewords as uncorrectable is used to force the altered data values to be subject to interpolation or other concealment means during playback of the data.

However, a data reader does not utilise error concealment means when reading data, although it may use further decoding and error correction means to try to further correct the data. If, therefore, the encoded and copy protected digital data produced by a method of the invention is decoded by a digital reader and is flagged as uncorrectable, the data may be subject to additional attempts at correction and/or the digital data, incorporating the altered values, is passed unchanged. If the data reader is being used as the input to a copier, for example, the altered values will be encoded onto the copy medium, such as a CD-DA. By this means, the copy produced will be degraded.

In a preferred embodiment, to ensure that the altered codewords are reliably identified as uncorrectable, the nature of the altered values and the number of data bytes altered are chosen such that, on decoding, the altered codeword will generate an uncorrectable error identifying syndrome.

For example, the syndrome is one which, in the decoding process, causes an error locator polynomial generated to have no roots.

Preferably, the uncorrectable error identifying syndrome is predetermined, for example, the syndrome is predetermined mathematically.

In a preferred embodiment, a corrupting vector is formed which has the same format as the selected codeword, the corrupting vector having altered values imposed onto a codeword in which all the data values are zero, and the method further comprising XORing the corrupting vector with the selected codeword whereby values in the selected codeword are XORed with the values in the corrupting vector to form the uncorrectable altered codeword.

A look up table containing a number of said corrupting vectors may be provided, each of the corrupting vectors in the look up table being known to produce an uncorrectable error identifying syndrome.

Preferably, the values of the data in the data bytes in a codeword are altered by XORing a large number to each of selected data bytes. This can be done, for example, by XORing an absolute value up to 128 to the values of each selected data byte. The added value may be chosen from the full range 127 to −128 to ensure that, irrespective of the original values, an unusually large magnitude will be produced.

In a preferred embodiment of the invention, the altered values are made in digital audio data. This might be in encoded audio data, for example, to be written onto a CD-DA.

In an embodiment, for copy protecting digital data encoded for application to a CD, the method further comprises altering four or more data bytes in selected C2 codewords.

Preferably, parity bytes of each C1 codeword incorporating a said altered data byte are additionally altered to render the said C1 codewords uncorrectable.

Preferably, the encoded digital data is audio data, and the values of the audio data bytes are altered such that they will provide audible clicks.

The present invention also extends to a data file containing information enabling digital data to be encoded and/or copy protected by methods as defined above.

The data file, as defined above, may be executable.

According to a further aspect of the present invention there is provided a medium on which copy protected encoded digital data has been stored, wherein the medium carries the encoded digital data arranged in codewords containing data bytes and parity values, wherein each of a plurality of data bytes in each of a number of selected codewords have had their values altered to form an altered codeword, the nature of the altered values and the number of data bytes altered in each selected codeword having been chosen to render the altered codeword uncorrectable.

Mediums of the invention are adapted for use with encoded digital data which can be successfully interpolated or subjected to error concealment after decoding for playback.

Whilst the present invention finds particular application for the copy protection of, for example, CD-DA's, its ability to reliably produce an error flag may be used in other contexts, for example, for watermarking, or to provide a signature.

All the features and advantages of the present invention will become apparent from the following detailed description of its preferred embodiment whose description should be taken in conjunction with the accompanying drawings.

### BRIEF DESCRIPTION OF THE DRAWINGS

Embodiments of the present invention will hereinafter be described, by way of example, with reference to the accompanying drawings, in which:

FIG. 1a shows a generator matrix for a code, and FIG. 1b shows a standard array generated by the operation of the generator matrix,

FIG. 2 shows schematically a CD,

FIG. 3 shows the format of a frame of data on a CD,

FIG. 4 shows schematically a CIRC encoder for data to be encoded on to a CD,

FIG. 5 shows a block of data after encoding,

FIG. 6 shows a CIRC decoder,

FIG. 7 shows schematically an audio player, and

FIG. 8 shows a circuit for applying a copy protection scheme of the invention to a CD,

FIG. 9 shows schematically the digital values of an audio waveform and shows the imposition of spikes,

FIG. 10 shows the decimal numbers 127 to −128 in the binary domain and in hexadecimal format,

FIG. 11 shows schematically a method of imposing altered values onto a codeword containing audio data, the altered values being of unusually large magnitude and being chosen to render the altered codeword uncorrectable, and

FIG. 12 shows schematically an overview of a method of the invention for protecting audio data.

### DETAILED DESCRIPTION OF THE INVENTION

The practice of encoding digital data was developed to ensure that the correct information was received over early communications channels, such as the telegraph, despite noise. Now, however, digital data is routinely encoded to allow any errors in the data to be detected and corrected. In this respect, the basic methods of the invention described herein are described with particular reference to the encoding and decoding of data on CD-DAs. However, it will be appreciated that these methods are equally applicable in any context where there is digital data which is to be encoded, for example, for reliability, and where errors in the digital data are to be concealed, on playback, by interpolation or other error concealment techniques.

The theories of error correcting codes will be known to those skilled in the art, and are not presented here. However, some basic concepts are now explained, by way of example, to aid understanding.

CD-DAs, and indeed CD-ROMs and similar formats, utilise Reed-Solomon codes for encoding and error detection. Reed-Solomon codes are a subclass of BCH codes, whilst BCH codes are a generalisation of Hamming codes.

We will look first at a simple linear, single error correcting (Hamming) code.

A message u, having k symbols, is encoded into a codeword or vector x, having n symbols, to produce a linear code. The first part of the codeword consists of the message itself, followed by n-k check symbols or parity values.

So, if the message is:

u=u₁ u₂ . . . uₖ

the codeword is

x=x₁ x₂ . . . xₖ . . . xₙ

where n>k, and u₁=x₁, u₂=x₂, . . . uₖ=xₖ

The check symbols are chosen so that

$${Hx}^{tr} = H ( \begin{matrix}{X}_{1} \\ {X}_{2} \\ ⋮ \\ {X}_{n}\end{matrix} ) = O$$

where H is the parity check matrix of the code.

The arithmetic is performed modulo 2, or XOR, ie 0+1=1, 1+1=0, −1=+1.

To generate a code from a message, the message u is operated upon by a generator matrix G to form the codeword x, ie

x=uG

The generator matrix G is related to the parity check matrix H and a set of independent codewords taken from a given code may be used as the rows of a generator matrix.

So, as indicated above, a message

u=u₁ u₂ . . . uₖ, becomes

codeword x=x₁ x₂ . . . xₖ . . . xₙ

On decoding, the system receives the received vector y=y₁ y₂ . . . yₖ . . . yₙ

The decoding system has to decide whether the received vector y is correct and is thus an accurate codeword. If it is determined that the received vector y is incorrect, the decoder attempts to correct the errors.

A useful way to decode a linear code is by utilising cosets. For an [n, k] linear code C as in the examples set out above, which will occupy a field with q elements, the set

a+C={a+x:xεC}

where a is any vector of the code C, is a coset of the code C. Each coset has q^{k} vectors.

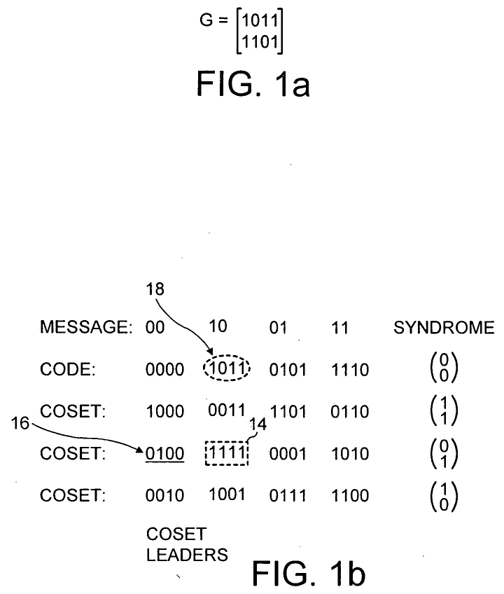

FIG. 1a shows a generator matrix G for a [4, 2] code, ie. a code where k=2 and n=4, and FIG. 1b shows a standard array showing a message, the code C generated from the message by the operation of the generator matrix G, and the three cosets generated from the code C. The three coset words in the left hand column of the array have the smallest number of nonzero values of the vectors in each coset and thus have the minimum weight. These minimum weight vectors are the coset leaders.

When a word of the received vector y is received, its position in the standard array is identified. If it is found in one of the cosets, the appropriate coset leader is identified as the likely error whereby the word can be decoded.

Thus, for example, if the y value received is 1111 as shown at location 14, its position in the array is found and that location determines that the appropriate coset leader is 0100, as shown at 16. The illustrated array shows that the correct codeword 18 is 1011. During decoding, the codeword 18 can be determined as 1111−0100=1011.

The last column in the array illustrated in FIG. 1b shows the syndrome S for each row of the array, which is defined as:

S=Hy^{tr}

and indicates the locations of errors. If there are no errors, the syndrome of y is 0. Furthermore, two vectors are in the same coset if they have the same syndrome. Basically, the syndrome contains all the information the receiver has about errors.

We will now look briefly at the encoding of digital data on CD-DAs and at the copy protection schemes described in WO 01/15028 and in GB 0116278.3

A digital audio compact disc (CD-DA), which carries music and is to be played on an audio player such as a conventional CD disc player, is made and recorded to a standard format known as the Red Book standards. As well as defining physical properties of the disc, such as its dimensions, and its optical properties, such as the laser wavelength, the Red Book also defines the signal format and the data encoding to be used.

As is well known, the use of the Red Book standards ensure that any CD-DA produced to those standards will play on any conventional audio player.

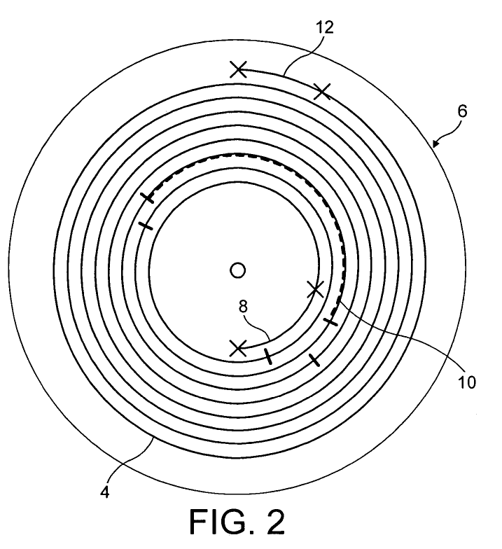

FIG. 2 shows schematically the spiral track 4 on a CD 6. This spiral track 4 on a CD-DA is divided into a Lead-In 8, a number of successive music or audio tracks as 10, and a Lead-Out 12. The Lead-In track 8 includes a Table of Contents (TOC) which identifies for the player the tracks to follow, whilst the Lead-Out 12 gives notice that the spiral track 4 is to end.

An audio player always accesses the Lead-In track 8 on start up. The music tracks may then be played consecutively as the read head follows the track 4 from Lead-In to Lead-Out. Alternatively, the player navigates the read head to the beginning of each audio track 10 as required.

To the naked eye, a CD-ROM looks exactly the same as a CD-DA and has the same spiral track 4 divided into sectors. However, data readers, such as CD-ROM drives, are enabled to read data, and process information, from each sector of the compact disc according to the nature of that data or information. A data reader can navigate by reading information from each sector whereby the read head can be driven to access any appropriate part of the spiral track 4 as required.

To ensure that any data reader can reader can read any CD-ROM, the compact discs are also made to standards known, in this case, as the Yellow Book standards. These Yellow Book standards incorporate, but extend, the Red Book standards. Hence, a data reader, such as a CD-ROM drive, can be controlled to play a CD-DA.

The ability of a data reader to access, extract, or otherwise read the data on a CD-DA provides a problem for the music industry. A user can use his CD-ROM drive to read the data from an audio disc, for example, into a computer file, and then that data can be copied. The increasing availability of recorders able to record onto compact discs means that individuals and organisations now have easy access to technology for making perfect copies of audio compact discs. This is of great concern to the music industry.

As the data encoding on a CD-DA and on a CD-ROM is well known and in accordance with the appropriate standards, it is not necessary to describe it in detail herein.

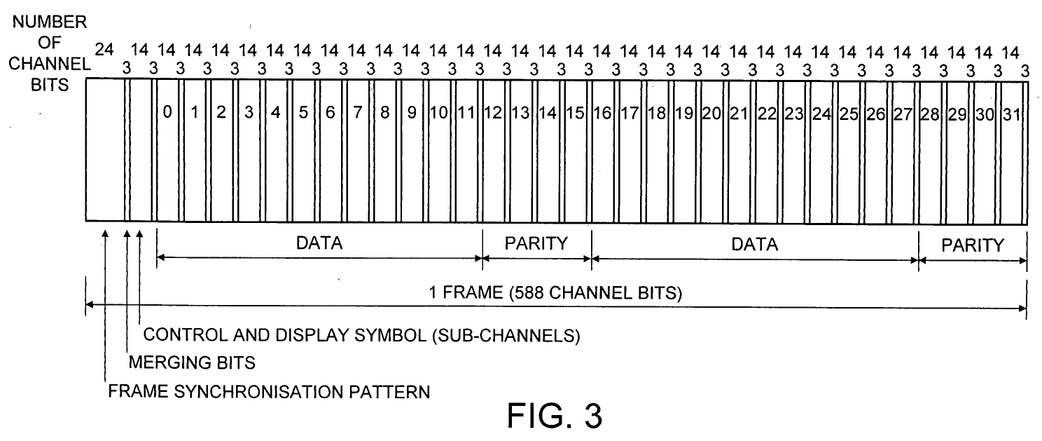

Briefly, the data on a CD is encoded into frames by EFM (eight to fourteen modulation). FIG. 3 shows the format of a frame, and as is apparent therefrom, each frame has sync data, sub-code bits providing control and display symbols, data bits and parity bits. Each frame includes 24 bytes of data, which, for a CD-DA, is audio data.

There are 8 sub-code bits contained in every frame and designated as P, Q, R, S, T, U, V and W. Generally only the P and Q sub-code bits are used in the audio format. The standard requires that 98 of the frames of FIG. 3 are grouped into a sector, and the sub-code bits from the 98 frames are collected to form sub-code blocks. That is, each sub-code block is constructed a byte at a time from 98 successive frames. In this way, 8 different subchannels, P to W, are formed. These subchannels contain control data for the disc. The P- and Q-subchannels incorporate timing and navigation data for the tracks on the disc, and generally are the only subchannels utilised on an audio disc.

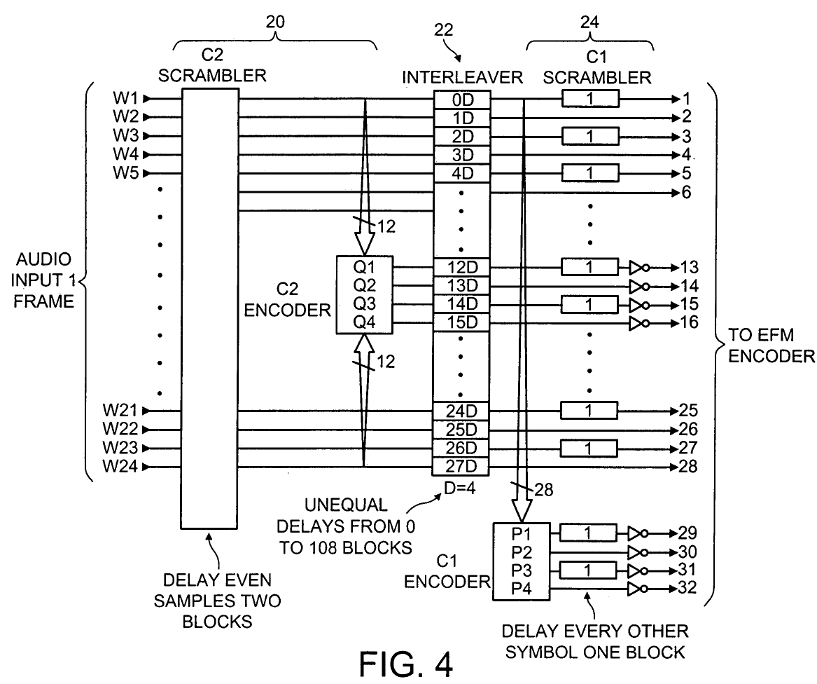

Before the data on a CD is subjected to EFM encoding and formed into the frame structure illustrated in FIG. 3, it is subjected to error correcting encoding. Specifically, the data to be stored on a CD is interleaved to facilitate the correction of burst errors, and has parity values incorporated for error correction. The particular algorithm used in the compact disc system is the Cross Interleave Reed-Solomon Code (CIRC) and an example of the CIRC encoding scheme is shown in FIG. 4. As can be seen, a C2 encoder 20 accepts 24 bytes of audio data, subjects some bytes to delay, and produces four bytes of Q parity values. Cross interleaving by way of an interleaver 22 follows the C2 encoder 20 whereby the 28 bytes are delayed by different periods. As a result of this interleaving, 28 different C2 codewords leave the C2 encoder.

A C1 encoder 24 accepts a 28 byte vector containing data from 28 different C2 codewords, and produces 4 more bytes of P parity values. The resulting 32 byte codewords leave the CIRC encoder of FIG. 4 and are applied to the EFM encoder.

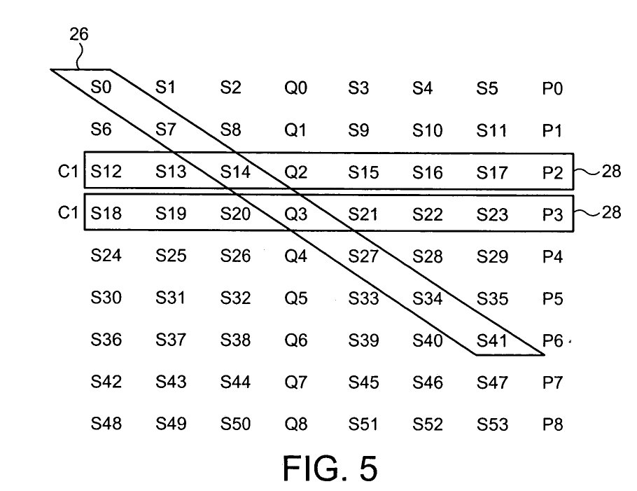

An example of a block of data produced by a CIRC encoder of FIG. 4 is illustrated in FIG. 5 where each S value represents 4 bytes of data, each 0 value represents 4 bytes of Q parity values, and each P value represents 4 bytes of P parity values. In addition, FIG. 5 illustrates the data rows, as 26, which are subject to decoding by a C2 decoder, and the data rows, as 28, which are subject to decoding by a C1 decoder.

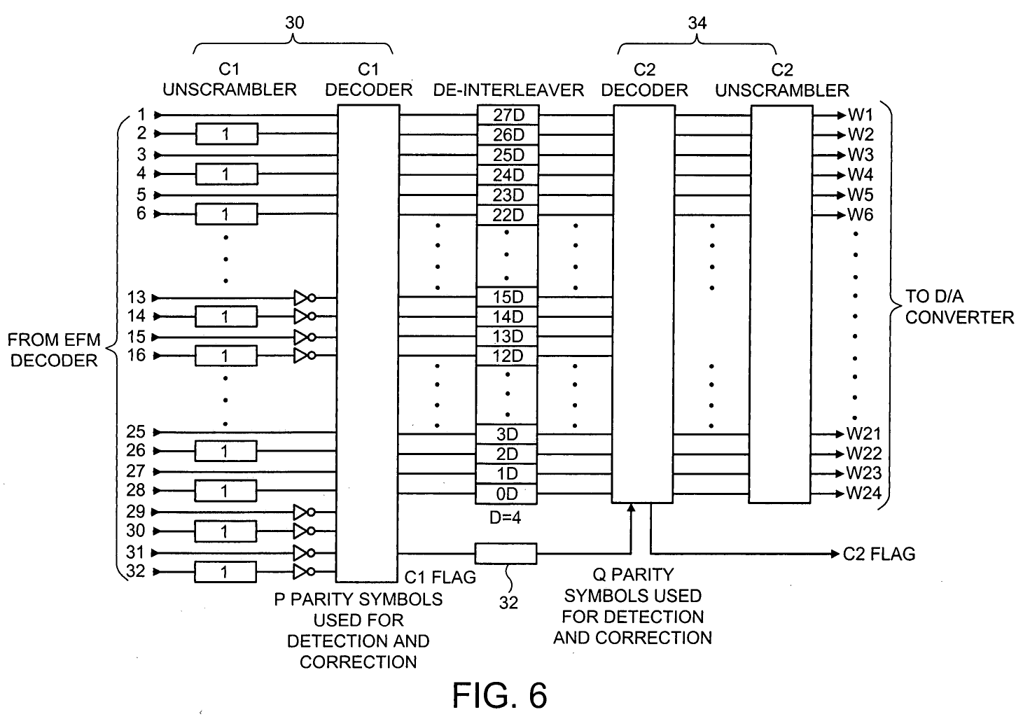

FIG. 6 shows schematically a CIRC decoder for decoding blocks of data from a CD. Thus, and as is known, the pits and lands on a CD are read and subject to EFM demodulation and are then applied to the CIRC decoder for de-interleaving, error detection and error correction. The data is input to the decoder in blocks as shown in FIG. 5 and is output as 24 bytes of audio data.

Thus, a frame of 32 8-bit bytes is applied to the decoder of FIG. 6. This frame of 32 bytes includes 24 bytes of audio data and 8 bytes of parity values. In a C1 decoder 30, errors are detected by the 4 P parity bytes and short duration random errors are corrected. Larger errors, for example, long burst errors, may result in a number of C1 rows being uncorrectable or having two correctable errors. These rows will be appropriately flagged. For example, advanced decoders may mark each erroneous row using erasure flags in the expectation that the errors can be corrected at the C2 stage. All bytes found to be valid are passed along unprocessed. Thus, the C1 decoder 30 flags any errors identified, but not corrected, as indicated at 32. A C2 decoder 34 passes all bytes without flags as error free if they also appear error free during C2 decoding. The C2 decoder 34 attempts to correct any remaining errors using the Q parity values and any error flags.

As indicated, during decoding the C1 rows are examined first to detect isolated errors and apply correction. C1 decoders are usually set to correct at most a single arbitrary erroneous word and therefore are able to detect error conditions in excess of this limit accurately, and to pass along error detection information, in the form of flags, to the C2 decoder 34. At the C2 decoder, a detected error within the error-correction limits results in the correction of the errors. However, a detected error in excess of the error-correction limits results in the generation of a C2 flag as indicated. A C2 flag signifies that an uncorrectable error has been detected.

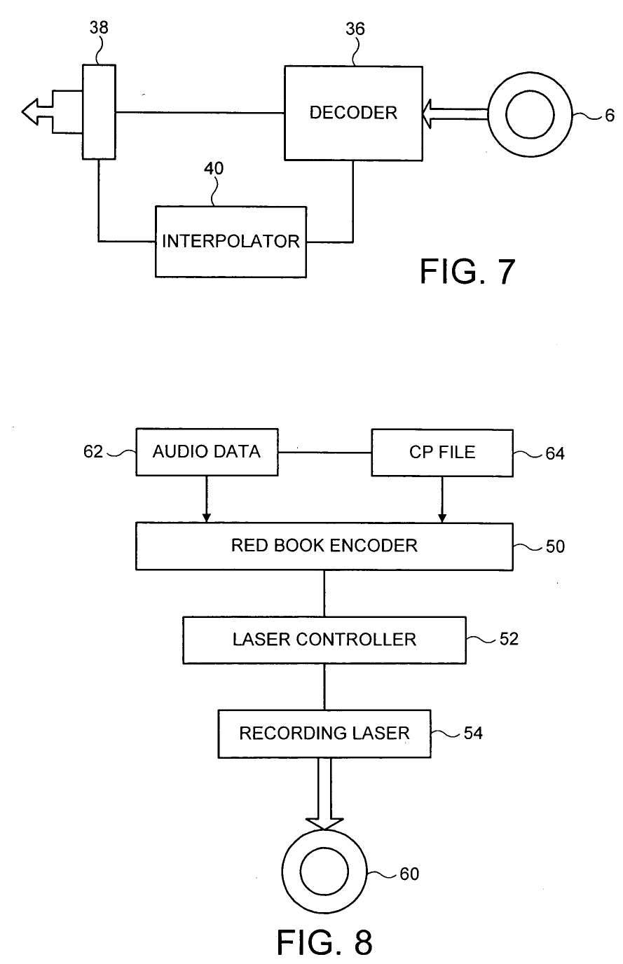

FIG. 7 shows schematically an audio player. As can be seen, the data from a CD-DA 6 is passed to a decoder, indicated at 36, which is arranged to decode discs having data encoded in accordance with Red Book standards, and then the decoded data may be fed directly to a sound reproduction device 38. However, where an uncorrectable error has been detected and a C2 flag generated, the data is fed via an error concealment unit 40 to the sound reproduction unit 38.

The nature of the error concealment unit 40 provided in an audio player varies and may, for example, incorporate sound muting circuits. In the illustrated embodiment, the error concealment unit 40 has been shown as an interpolator 40.

It will be appreciated that an audio waveform is generally continuous and that if an error produces a discontinuity in the waveform, the missing value can generally be interpolated. In most cases, this interpolation produces a waveform which is a good approximation to the original. However, where a data reader, for example, is being used to access digital data, interpolation cannot be used as the value of one data byte does not necessarily have a relationship to the data byte which is next retrieved. This provides a method of copy protecting CA-DAs, which copy protection scheme will allow play of a CD by an audio player whilst causing any attempt at copying the audio in the digital domain to be significantly degraded.

Basically, for copy protection, noise is incorporated in the audio data recorded on the disc and is associated with error correction words which identify the added noise as uncorrectable and thereby cause the generation of a C2 flag as described above. Such data will be passed by an audio player to an interpolator, as 40, which is able to remove the added noise and substitute a more appropriate audio value. However, a data reader will simply read the audio data, flagged as uncorrectable, so that the added noise is written to disc, for example, during copying. The copy disc, therefore, is significantly degraded.

A method of copy protecting CD-DAs by flagging introduced, added noise on a disc as uncorrectable is proposed in WO 01/15028 and in GB 0116278.3. These specifications propose altering the audio data by the addition of data of unusually large magnitudes, (hereinafter “spikes”), and then changing the parity bytes associated with the C1 and C2 rows containing the changed audio data such that the altered audio data is identified, and flagged, as uncorrectable. Generally, the scheme proposed in WO 01/15028 is to replace C2 parity bytes with unused symbols and to replace C1 parity bytes with zeros. GB 0116278.3 proposes changing the audio and parity data in each row so that the associated syndrome indicates to the decoder that the data in the row is uncorrectable. This is done by altering the parity values in all codewords containing the introduced altered values.

With a copy protection scheme as proposed in which spikes are to be added to the audio data on a CD-DA to produce clicks it is imperative to ensure that all audio players are triggered to use their interpolators to remove the spikes no matter how sophisticated the decoder provided and irrespective of its methods of error correction. Clearly, the music industry will be unwilling to incorporate a copy protection technique if there is a significant risk that the added noise will be audible when the consumer plays a genuine CD-DA on a typical consumer audio player.

As set out above, with the methods described in WO 01/15028 and GB 0116278.3, the values of data in a codeword are changed in order to impose a spike on an audio sample. Other alterations are made to the parity bytes to flag the error as uncorrectable. In all, alterations may have to be made to render one C2 row and five C1 rows uncorrectable to produce a single uncorrectable spike.

With the present invention it is only data bytes in the C2 rows, rather than parity bytes, which are altered or corrupted. For example, five or six data bytes in one C2 row can be altered to thereby produce five or six spikes. Thus, five to twelve clicks can be obtained from one uncorrectable C2 row, each such click also requiring one uncorrectable C1 row. Thus, a copy of an audio disc protected by embodiments of the present invention has more noise superimposed thereon compared to methods described in previous inventions, but the number of bytes corrupted has not increased.

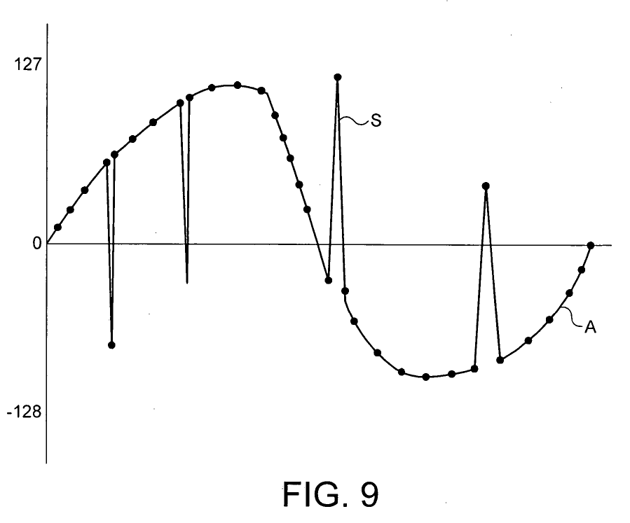

FIG. 9 shows schematically the digital values of an analog audio waveform against time. Thus, in FIG. 9 the audio waveform is shown at A. It will be appreciated that each point on the waveform A can be given a value and where those values are to be digitized in 8-bit bytes there are 256 possible values which can be associated with the waveform. The audio waveform A is shown in FIG. 9 as varying between the values 127 and −128.

As in the earlier cases, specific values of the digitized audio waveform are to be altered to cause spikes which are audible as clicks if played. In FIG. 9, it is assumed that four individual values have been altered by the addition thereto of the highest absolute value, which is 128. By this means, spikes as S shown in FIG. 9 can be produced. It will be seen that the spikes S are superimposed onto the audio waveform A and it is known that such impulses as illustrated in FIG. 9 will cause clicks if played. It will be appreciated that if −128 is added to a 8-bit two's-complement negative number, for example −x, then the result is a positive number 128−x.

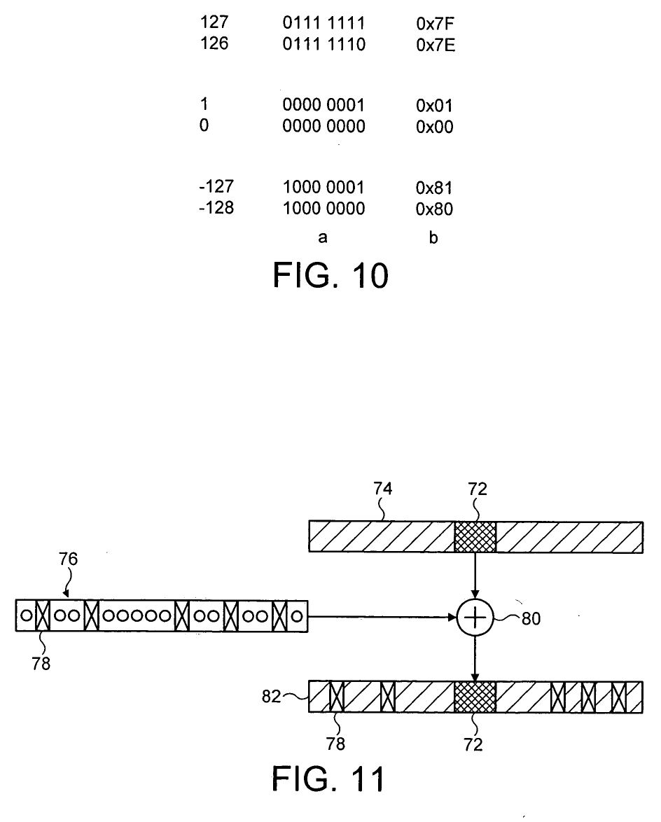

Column a of FIG. 10 indicates the values 127 to −128 in binary notation, whilst column b gives the same numbers in the hexadecimal system. From this, it will be seen that XORing a number from 0x80 to 0x8F (or a similar number with a large magnitude) with appropriate bytes of the audio data will produce a click.

In this respect, rather than altering an 8-bit data byte in order to alter the data values, it would alternatively be possible to alter just the most significant nibble, for example, by XORing that nibble with 8. Similarly, it would be possible to group the data bytes into multibyte numbers and to alter the most significant bytes (MSBs) of these numbers.

It will be appreciated that the data bytes in a C2 row are to be altered both to produce a number of clicks and to cause the C2 row, on decoding, to be flagged as uncorrectable. If the most significant bits only of selected data bytes are XORed to produce the unusually large magnitude values, and hence the clicks, the least significant bits can be changed without recourse to the need to produce a click, but only with a view to generating the desired syndrome on decoding. In this respect, in one embodiment the most significant nibble of each selected data byte is used to produce the click, whilst the least significant nibble is used to generate the desired syndrome on decoding. However, the number of upper order bits from each data byte which are to be used to produce the click can be chosen as required, with the remaining lower order bits being used to generate the desired syndrome on decoding.

In the one embodiment, five clicks are produced on an audio sample by choosing five MSB's to alter. Each MSB is XORed with a number from 0x80 to 0x8F.

As explained above, in an embodiment of the invention, five data bytes in a C2 row are to be altered both to produce five audible clicks and to render the C2 row uncorrectable. This is distinct from the earlier cases referred to where audio data is altered to produce spikes and parity data is altered to cause the C2 row to be flagged as uncorrectable. Most decoders will flag a row as uncorrectable if it is found to have more than four errors. Accordingly, the values imposed on the altered data bytes have to be chosen not only so that the audible click will be produced but also so that the C2 row will be rendered uncorrectable.

As set out above, a C2 codeword has 24 bytes of data which may be arranged as 6 4-byte or 6 2-word numbers together with the 4 bytes of Q parity values. In one practical embodiment, to choose the altered values for the data, a selection of five values is chosen and these values are XORed into an all zero codeword having the form of a C2 row to replace five of the most significant bytes (MSBs) in the 6 numbers.

The values put into the all zero codeword will be numbers from 0x80 to 0x8F. The resultant vector, which is to be a corrupting vector, is decoded to see whether or not it is uncorrectable. There is at least a 50% chance that a random vector made up in this manner will be in one of the cosets of uncorrectable vectors where the decoding algorithm fails due to the error locator polynomial not having any roots. If this first selection of values results in a vector in the correct coset then the corrupting vector containing these values can be used to alter the data values of codewords from the audio sample as illustrated in FIG. 11. Of course, if the first selection of values does not result in a vector in a correct coset, alternative values can be chosen.

In a variation of this embodiment, which may make it more difficult for counterfeiters to remove the spikes, one of the five MSBs to be altered is given an arbitrary value. The values of the other four MSBs may be calculated so that the resultant corrupting vector on decoding has the desired syndrome.

FIG. 11 illustrates schematically a method of the invention in which a row 74 of encoded audio data is associated with a corrupting vector 76 which incorporates audible clicks. In this respect, the corrupting vector 76 generally contains all zeros except for five data locations at each of which a respective audio click 78 is incorporated. The corrupting vector 76 is XORed at 80 with the codeword 74 to produce the altered codeword 82. This altered codeword 82 has the audible clicks 78 imposed on the normal audio data from the original codeword 74. It will be seen that the altered codeword 82 has the same parity values 72 as the original codeword 74. However, as the vector 76 has been chosen to alter the data values in the codeword 82 to render the codeword uncorrectable, it is to be expected that when the altered codeword 82 is decoded it will force interpolation or other error concealment.

As well as altering the data values in a single C2 codeword 74, as shown in FIG. 11, the C1 rows in which each of the altered data values occurs are altered in order to render those C1 rows uncorrectable. It is preferred that the parity bytes of the C1 rows are altered, for example, as described in GB 0116278.3.

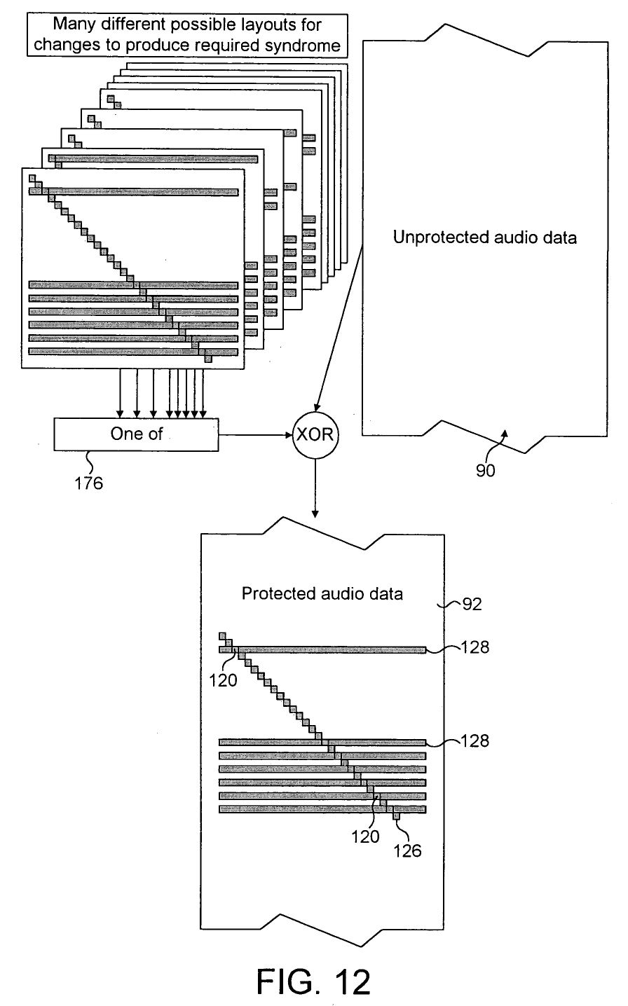

FIG. 12 shows schematically an overview of a method of the invention for copy protecting audio data. Thus, individual rows of encoded audio data in a block of audio data 90 are each XORed in their turn with a corrupting vector from a pattern of corrupting vectors 176, as chosen above, to produce protected and encoded audio data 92.

As set out above, a corrupting vector may be formed by XORing chosen values into an all zero codeword having the form of a C2 codeword. This corrupting vector is then XORed with a C2 codeword to form an altered C2 codeword. It can be shown that if nine or more MSBs of the corrupting vector, and hence of the C2 codeword, are altered all possible combinations of syndrome can be generated on decoding. Thus, corrupting nine or more MSBs would enable a choice to be made of a specific syndrome. However, for practical purposes, corrupting seven MSBs is generally sufficient to achieve a desired syndrome.

It has been made clear above that in a preferred embodiment seven MSBs of a C2 codeword may be altered to form an altered C2 codeword 126, as indicated in FIG. 12. These altered MSBs, indicated at 120, occur in seven C1 rows 128 and parity bytes in each of these C1 rows 128 have been altered to render those C1 rows uncorrectable.

FIG. 8 shows a system for copy protecting an audio compact disc. As is conventional, an encoder 50, for encoding discs according to Red Book standards, and referred to hereinafter as a “Red Book encoder” receives incoming data for encoding and application, by way of a laser controller 52 and a recording laser 54, on to a master disc 60. Generally, the data fed to the Red Book encoder 50 will be audio data from a source 62. However, with the invention, the modifications to the data as discussed above are caused by the copy protection software which is fed from a copy protection file source 64 to the Red Book encoder 50 in tandem with the audio data 62. This system is particularly useful for use with the method shown schematically in FIGS. 11 and 12 as selected rows 74 of audio data 62 read from the source 62 can be XORed with corrupting rows as 76.

It will be appreciated that variations and modifications may be made to the embodiments described and illustrated within the scope of the accompanying claims.

1. A method of copy protecting encoded digital data, wherein the encoded digital data has been subjected to error correcting encoding and is arranged in codewords, each codeword containing data bytes and parity values, the method comprising altering the values of the data in a plurality of data bytes in a selected codeword, to form an altered codeword, the nature of the altered values and the number of data bytes altered being chosen to render the altered codeword uncorrectable.

2. A method as claimed in claim 1, wherein the values of the data in at least four data bytes in the selected codeword are altered.

3. A method as claimed in claim 1, wherein the values of the data in at least five data bytes in the selected codeword are altered.

4. A method of copy protecting encoded digital data, wherein the encoded digital data has been subjected to error correcting encoding and is arranged in codewords, each codeword containing data bytes and parity values, the method comprising altering the values of the data in a plurality of data bytes in a selected codeword, to form an altered codeword, the nature of the altered values and the number of data bytes altered being chosen to render the altered codeword uncorrectable, and wherein one or more higher order bits of each data byte of the plurality of data bytes are altered to be representative of an unusually large magnitude, and the remaining lower order bits of each data byte of the plurality of data bytes are altered such that, on decoding, the altered codeword will generate an uncorrectable error identifying syndrome.

5. A method as claimed in claim 4, wherein the most significant nibble of each data byte of the plurality of data bytes is altered to be representative of an unusually large magnitude, and wherein the least significant nibble of each data byte of the plurality of data bytes is altered to generate the uncorrectable error identifying syndrome on decoding.

6. A method of copy protecting encoded digital data, wherein the encoded digital data has been subjected to error correcting encoding and is arranged in codewords, each codeword containing data bytes and parity values, the method comprising altering the values of the data in a plurality of data bytes in a selected codeword, to form an altered codeword, the nature of the altered values and the number of data bytes altered being chosen to render the altered codeword uncorrectable, and wherein the nature of the altered values and the number of data bytes altered are chosen such that, on decoding, the altered codeword will generate an uncorrectable error identifying syndrome.

7. A method as claimed in claim 6, wherein the syndrome is one which, in the decoding process, causes an error locator polynomial to have no roots.

8. A method of copy protecting encoded digital data, wherein the encoded digital data has been subjected to error correcting encoding and is arranged in codewords, each codeword containing data bytes and parity values, the method comprising altering the values of the data in a plurality of data bytes in a selected codeword, to form an altered codeword, the nature of the altered values and the number of data bytes altered being chosen to render the altered codeword uncorrectable, and wherein a corrupting vector is formed which has the same format as the selected codeword, the corrupting vector having altered values imposed on a codeword in which all of the data values are zero, and further comprising XORing the corrupting vector with the selected codeword whereby values in the selected codeword are XORed with the values in the corrupting vector to form the uncorrectable altered codeword.

9. A method of copy protecting encoded digital data, wherein the encoded digital data has been subjected to error correcting encoding and is arranged in codewords, each codeword containing data bytes and parity values, the method comprising altering the values of the data in a plurality of data bytes in a selected codeword, to form an altered codeword, the nature of the altered values and the number of data bytes altered being chosen to render the altered codeword uncorrectable, and wherein one or more higher order bits of each data byte of the plurality of data bytes are altered to be representative of an unusually large magnitude, and the remaining lower order bits of each data byte of the plurality of data bytes are altered such that, on decoding, the altered codeword will generate an uncorrectable error identifying syndrome, and wherein a corrupting vector is formed which has the same format as the selected codeword, the corrupting vector having altered values imposed on a codeword in which all of the data values are zero, and further comprising XORing the corrupting vector with the selected codeword whereby values in the selected codeword are XORed with the values in the corrupting vector to form the uncorrectable altered codeword.

10. A method as claimed in claim 8 or claim 9, wherein a look up table containing a number of said corrupting vectors is provided, each of the corrupting vectors in the look up table being known to produce an uncorrectable error identifying syndrome.

11. A method of copy protecting encoded digital data, wherein the encoded digital data has been subjected to error correcting encoding and is arranged in codewords, each codeword containing data bytes and parity values, the method comprising altering the values of the data in a plurality of data bytes in a selected codeword, to form an altered codeword, the nature of the altered values and the number of data bytes altered being chosen to render the altered codeword uncorrectable, the method being for copy protecting digital data encoded for application to a CD, wherein four or more data bytes in selected C2 codewords are altered.

12. A method as claimed in claim 11, wherein parity bytes of each C1 codeword incorporating a said altered data byte are additionally altered to render the said C1 codewords uncorrectable.

13. A method as claimed in claim 11, wherein the encoded digital data is audio data, and wherein the values of the audio data bytes are altered such that they will provide audible clicks.

14. A data file containing information for enabling encoded digital data to be copy protected, the encoded digital data being arranged in codewords containing data bytes and parity values, the information contained in the data file enabling the values of a plurality of data bytes in each of a number of selected codewords to be altered, where the nature of the altered values and the number of data bytes in each altered codeword are chosen to render the altered codeword uncorrectable.

15. A data file as claimed in claim 14, which is arranged to be executable.

16. A medium on which copy protected encoded digital data has been stored, wherein the medium carries the encoded digital data arranged in codewords containing data bytes and parity values, wherein each of a plurality of data bytes in each of a number of selected codewords have had their values altered, the nature of the altered values and the number of data bytes altered in each altered codeword having been chosen to render the altered codeword uncorrectable.

17. A medium as claimed in claim 16, wherein the values of the data in at least four data bytes in the selected codeword are altered.

18. A medium as claimed in claim 16, wherein the values of the data in at least five data bytes in the selected codeword are altered.

19. A medium on which copy protected encoded digital data has been stored, wherein the medium carries the encoded digital data arranged in codewords containing data bytes and parity values, wherein each of a plurality of data bytes in each of a number of selected codewords have had their values altered, the nature of the altered values and the number of data bytes altered in each altered codeword having been chosen to render the altered codeword uncorrectable, and wherein one or more higher order bits of each data byte of the plurality of data bytes are altered to be representative of an unusually large magnitude, and the remaining lower order bits of each data byte of the plurality of data bytes are altered such that, on decoding, the altered codeword will generate an uncorrectable error identifying syndrome.

20. A medium as claimed in claim 19, wherein the most significant nibble of each data byte of the plurality of data bytes is altered to be representative of an unusually large magnitude, and wherein the least significant nibble of each data byte of the plurality of data bytes is altered to generate the uncorrectable error identifying syndrome on decoding.

21. A medium on which copy protected encoded digital data has been stored, wherein the medium carries the encoded digital data arranged in codewords containing data bytes and parity values, wherein each of a plurality of data bytes in each of a number of selected codewords have had their values altered, the nature of the altered values and the number of data bytes altered in each altered codeword having been chosen to render the altered codeword uncorrectable, and wherein the nature of the altered values and the number of data bytes altered are chosen such that, on decoding, the altered codeword will generate an uncorrectable error identifying syndrome.

22. A medium as claimed in claim 21, wherein the syndrome is one which, in the decoding process, causes an error locator polynomial to have no roots.

23. A medium on which copy protected encoded digital data has been stored, wherein the medium carries the encoded digital data arranged in codewords containing data bytes and parity values, wherein each of a plurality of data bytes in each of a number of selected codewords have had their values altered, the nature of the altered values and the number of data bytes altered in each altered codeword having been chosen to render the altered codeword uncorrectable, and wherein a corrupting vector is formed which has the same format as the selected codeword, the corrupting vector having altered values imposed on a codeword in which all of the data values are zero, and further comprising XORing the corrupting vector with the selected codeword whereby values in the selected codeword are XORed with the values in the corrupting vector to form the uncorrectable altered codeword.

24. A medium as claimed in claim 23, wherein a look up table containing a number of said corrupting vectors is provided, each of the corrupting vectors in the look up table being known to produce an uncorrectable error identifying syndrome.

25. A medium on which copy protected encoded digital data has been stored, wherein the medium carries the encoded digital data arranged in codewords containing data bytes and parity values, wherein each of a plurality of data bytes in each of a number of selected codewords have had their values altered, the nature of the altered values and the number of data bytes altered in each altered codeword having been chosen to render the altered codeword uncorrectable, wherein the medium is a CD and the encoded and copy protected digital data has been applied onto the CD, wherein four or more data bytes in selected C2 codewords have been altered.

26. A CD as claimed in claim 25, wherein parity bytes of each C1 codeword on the CD incorporating a said altered data byte have been additionally altered to render the said C1 codewords uncorrectable.

27. A CD as claimed in claim 25, wherein the encoded digital data is audio data, and wherein the values of the audio data bytes have been altered such that they will provide audible clicks.
